(19) United States
(12) Patent Application Publication
(10) Pub. No.: US 2009/0296797 A1
(43) Pub. Date: Dec. 3, 2009

(54) Data Description Method and Related Packet and Testing System for a Serial Transmission Interface

(76) Inventors: Wei-Yi Wei, Nantou County (TW); Chien-Yu Wei, Hsinchu County (TW); Chih-Wei Tang, Penghu County (TW)

Correspondence Address: NORTH AMERICA INTELLECTUAL PROPERTY CORPORATION, P.O. BOX 506, MERRIFIELD, VA, 22116, US

(21) Appl. No.: 12/211,097

(22) Filed: Sep. 15, 2008

(30) Foreign Application Priority Data
May 27, 2008 (TW) 097119515

(51) Int. Cl. H04B 17/00

(52) U.S. Cl. 375/228

(57) ABSTRACT

A data description method for a serial transmission interface includes generating a low-speed data and a high-speed data simultaneously, sampling the low-speed data to generate a first sampling result according to a first sampling rate within a specified duration, sampling the high-speed data to generate a second sampling result according to a second sampling rate within the specified duration, and combining the first sampling result and the second sampling result to describe contents of the low-speed data and the high-speed data within the specified duration.

### BACKGROUND OF THE INVENTION

1. Field of the Invention

The present invention is related to a data description method and related packet and testing system for a serial transmission interface, and more particularly, to a data description method and related packet and testing system for decreasing the number of bits used for describing a low speed transmission data and improve the overall efficiency.

2. Description of the Prior Art

Since the high bandwidth wireless communication service has become prevalent in public, audio and video transmission get even wider application in the wireless communication. Also, various mobile terminal products for many kinds of multimedia applications have been diversified and are getting more popular, and many of them require considerable transmission bandwidth. The traditional audio/video transmission interface adopts a totally parallel architecture, and transmits data through a plurality of paths. However, as audio/video data become greater in the number of bits, if we choose to accommodate the demand by extending the data bus width, not only the efficiency of space usages would decrease owing to the number of wirings, but also the electromagnetic interference and radiation itself would increase while the data rate becomes higher.

Therefore, to provide a satisfactory solution to the problem mentioned above, the prior art comprises various serial transmission interfaces for improving the efficiency and suppressing electromagnetic interference, and Mobile Industry Processor Interface (MIPI) is one example of the serial transmission interfaces. There are numerous factors for a designer to consider which serial transmission interface is best for connecting between a mobile device and a multimedia peripheral device. Those design factors may include power consumption, signal bandwidth, signal transmission distance, realization cost, noise susceptibility, and number of pins. Furthermore, after the designer completes a design of a mobile communication device, the design should be under test for the system requirements through specific procedures in different testing environments, such that the design can be optimized successively.

For example, please refer to FIG. 1. FIG. 1 shows a schematic diagram of a testing system 10 used for a serial transmission interface 100 in the prior art. The testing system 10 comprises a signal generator 102, a transmission unit 104 and a reception unit 106. The signal generator 102 is used for generating different signal patterns, and outputting those patterns to the transmission unit 104 in the serial format or in the parallel format. The transmission unit 104 transforms the signal pattern generated by the signal generator 102 to a predefined format specified by the serial transmission interface 100, and transmits it to the reception unit 106. The reception unit 106 is built in a mobile device, and used for receiving the signal patterns output from the transmission unit 104 via the serial transmission interface 100, to control their corresponding application programs AP_1˜AP_n. Then, the designer can judge the performance of the mobile device based on those testing results.

However, according to the architecture mentioned above, while the signal pattern output from the signal generator 102 is used for describing the high/low speed serial signal, the system will sample the low-speed signal based on the data rate of the high-speed signal. If there is a large difference in sampling rate between the high-speed data and the low-speed data, using the high sampling rate to sample the low-speed data will make the sampling result too verbose and bulky. FIG. 2 shows a schematic diagram of both the high-speed and the low-speed data generated by the signal generator 102. FIG. 3 shows a sampling result according to the signal diagram shown in FIG. 2. Inside FIG. 2, as depicted from the top of this drawing, HSS denotes high speed signal, HSD denotes high-speed data, HSC denotes high speed clock, LSS denotes low speed signal, LSD denotes low-speed data, LSC denotes low speed clock, HLSC denotes high/low speed clock, SS denotes speed switching data, SP denotes sampling point, SD denotes serial data, and SC denotes serial clock. HSD, LSD and SS are the signal patterns generated by the signal generator 102. SD and SC are the format signals used in the serial transmission interface 100. SS is used for switching of SD data between HSD and LSD. SS is also used for switching of SC clock between HSC and LSC. Therefore, as illustrated in FIG. 2 and FIG. 3, to describe the high/low speed serial signal, the prior art uses the sampling rate of the high speed signal to describe the low speed signal, and the resulting low-speed data become too bulky and contains too many redundant messages.

### SUMMARY OF THE INVENTION

The present invention discloses a data description method for a serial transmission interface, which comprises generating a low-speed data and a high-speed data simultaneously, sampling the low-speed data to generate a first sampling result according to a first sampling rate within a specified duration, sampling the high-speed data to generate a second sampling result according to a second sampling rate within the specified duration, and combining the first sampling result and the second sampling result to describe contents of the low-speed data and the high-speed data within the specified duration.

The present invention further discloses a packet for describing a high-speed data and a low-speed data in a serial transmission interface, which comprises a first field comprising a first number of binary data for describing a first sampling result generated by sampling the low-speed data at a first sampling rate within a specified duration, and a second field comprising a second number of binary data for describing a second sampling result generated by sampling the high-speed data at a second sampling rate within a specified duration.

The present invention further discloses a testing system for testing a communication device, which comprises a reception unit built inside the communication device for receiving a test pattern, a transmission unit for outputting the test pattern, a serial transmission interface coupled between the reception unit and the transmission unit for transmitting the test pattern, a data transformation unit coupled to the serial transmission interface for transforming a description content to generate the test pattern, and a data processing unit coupled to the data transfer unit for generating a low-speed data and a high-speed data simultaneously, sampling the low-speed data to generate a first sampling result according to a first sampling rate within a specified duration, sampling the high-speed data to generate a second sampling result according to a second sampling rate within the specified duration, and combining the first sampling result and the second sampling result to describe contents of the low-speed data and the high-speed data within the specified duration.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a testing system used for a serial transmission interface in the prior art.

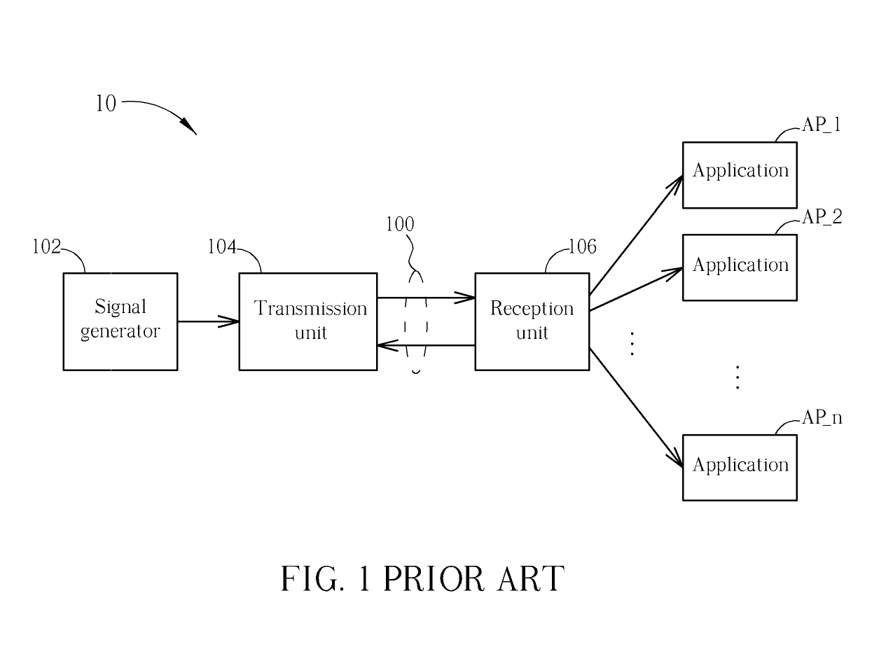

FIG. 2 illustrates a schematic diagram of a high/low speed serial transmission signal generated by a signal generator shown in FIG. 1.

FIG. 3 illustrates a schematic diagram of a sampling result corresponding to FIG. 2.

FIG. 4 illustrates a schematic diagram of a testing system used for testing a communication unit according to an embodiment of the present invention.

FIG. 5 illustrates a schematic diagram of a data description flowchart of a data processing unit shown in FIG. 4.

FIG. 6 illustrates a schematic diagram of a high/low speed serial transmission signal generated by a data processing unit shown in FIG. 4.

FIG. 7 illustrates a schematic diagram of a sampling result corresponding to FIG. 6.

FIG. 8 illustrates a schematic diagram of two sets of the high/low speed serial transmission signal generated by a data processing unit shown in FIG. 4.

FIG. 9 illustrates a schematic diagram of a sampling result corresponding to FIG. 8.

FIG. 10 illustrates a schematic diagram of two sets of the high/low speed serial transmission signal generated by a data processing unit shown in FIG. 4.

FIG. 11 illustrates a schematic diagram of a sampling result corresponding to FIG. 10.

### DETAILED DESCRIPTION

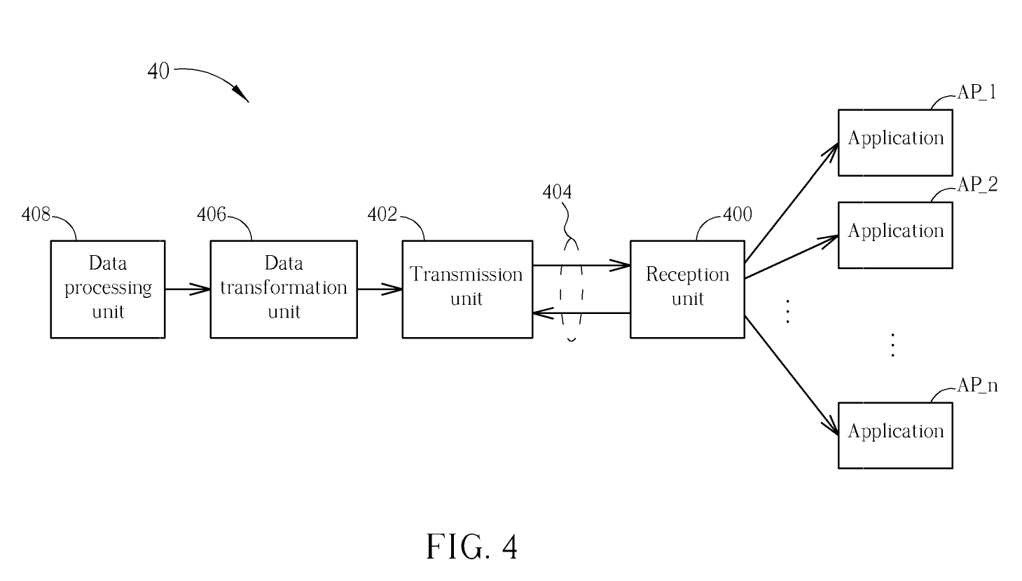

Please refer to FIG. 4. FIG. 4 shows a schematic diagram of a testing system 40 used for testing a communication device in accordance with an embodiment of the present invention. The testing system 40 comprises a reception unit 400, a transmission unit 402, a serial transmission interface 404, a data transformation unit 406 and a data processing unit 408. Inside the testing system 40, the data processing unit 408 is used for generating a description content, the data transformation unit 406 transforms the description unit into a test pattern, the transmission unit 402 sends the test pattern to the reception unit 400 via the serial transmission interface 404. The communication device built in the reception unit 400 will perform the application AP_1˜AP_n accordingly upon receiving the test pattern, such that the designer can judge the performance of the communication device.

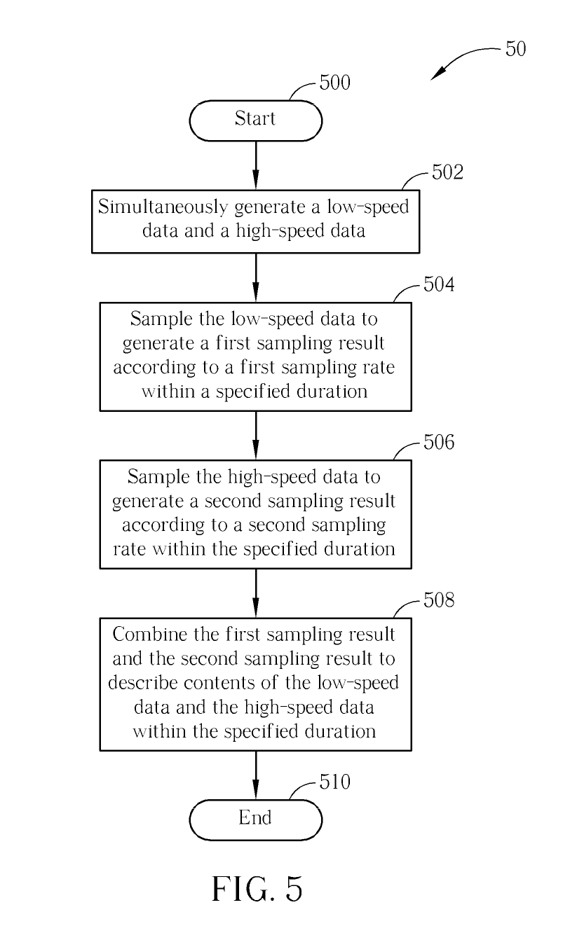

Furthermore, please refer to FIG. 5. FIG. 5 is a schematic diagram of a data description flowchart 50 of the data processing unit 408. The data description flowchart 50 is used for generating description contents, and comprises the following steps:

STEP 500: Start

STEP 502: Simultaneously generate a low-speed data and a high-speed data.

STEP 504: Sample the low-speed data to generate a first sampling result according to a first sampling rate within a specified duration.

STEP 506: Sample the high-speed data to generate a second sampling result according to a second sampling rate within the specified duration.

STEP 508: Combine the first sampling result and the second sampling result to describe contents of the low-speed data and the high-speed data within the specified duration.

STEP 510: End

According to the flowchart 50, while the description content is generated by the data processing unit 408, the data processing unit 408 produces a low-speed data and a high-speed data simultaneously. Next, within a specified duration, the present invention will sample the low-speed data to generate a first sampling result according to a first sampling rate, and sample the high-speed data to generate a second sampling result according to a second sampling rate. Eventually, the present invention will combine the first sampling result and the second sampling result to describe contents of the low-speed data and the high-speed data within the specified duration. Briefly speaking, the present invention uses different sampling rates to sample the high-speed data and the low-speed data respectively. Preferably, the first sampling rate corresponds to the transmission rate of the low-speed data, and the second sampling rate corresponds to the transmission rate of the high-speed data. Under this condition, the sampling result of the low-speed data is expressed in the serial format, and the high-speed data is expressed in the parallel format. Consequently, the number of bits contained in the sampling result of the low-speed data decreases substantially.

In the prior art, when describing the high/low speed serial signals, the prior art uses the high speed sampling clock to sample both the high and low speed signals, and the size of resulting low-speed data becomes unnecessarily huge. Compared with the present invention, through the flowchart 50, the data processing unit 408 expresses the sampled data with low speed in the serial format, and the sampled data with high speed in the parallel format, and the number of bits used for describing the low-speed data can be decreased effectively.

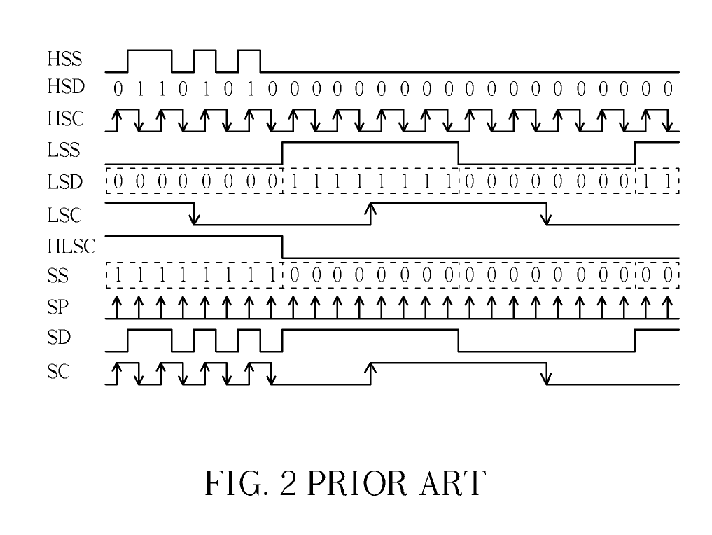

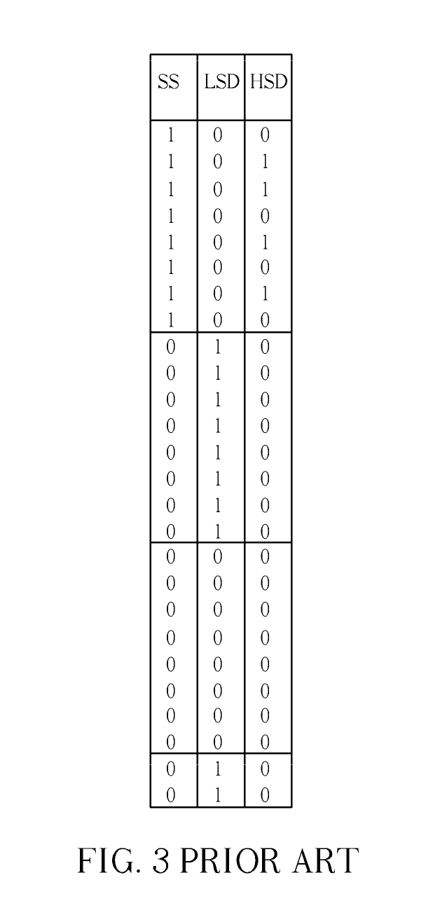

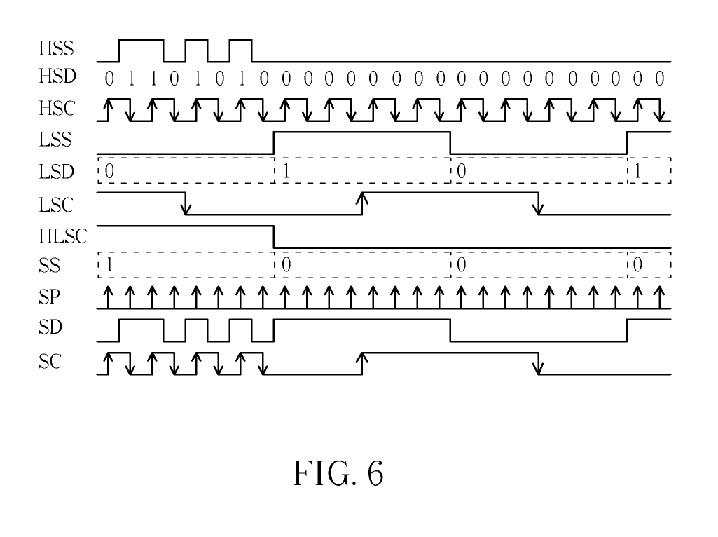

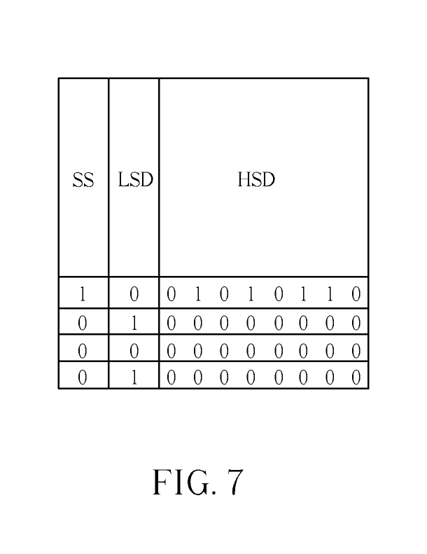

For example, please refer to FIG. 6 and FIG. 7. FIG. 6 shows the high/low speed serial transmission signals generated by the data processing unit 408. FIG. 7 shows the sampled result corresponding to FIG. 6. FIG. 7 also shows the description contents generated by the data processing unit 408. For clearly illustrating the present invention, the definition of the symbols used in FIG. 6 and FIG. 7 are the same as those used in FIG. 2 and FIG. 3. HSD, LSD and SS are signal patterns generated by the data transformation unit 406. SD and SC are format signals used in the serial transmission interface 404. SS is used for switching of SD data between HSD and LSD. SS is also used for switching of SC clock between HSC and LSC. As shown in FIG. 6, the high-speed data is described by a sampling rate of higher speed, and the low-speed data is described by a sampling rate of lower speed. Therefore, as shown in FIG. 7, the number of bits included in the field corresponding to the sampling result of the low-speed data is obviously less than the number of bits corresponding to the sampling result of the high-speed data. Meanwhile, the sampling result of the low-speed data is expressed in the serial format, and the sampling result of the high-speed data is expressed in the parallel format. Under these circumstances, not only the number of bits used for describing the low-speed data is decreased, but also the sampling result of the high-speed data can be expressed in the parallel format such that data transformation unit 406 can get more time to process the sampling result and increase the general performance.

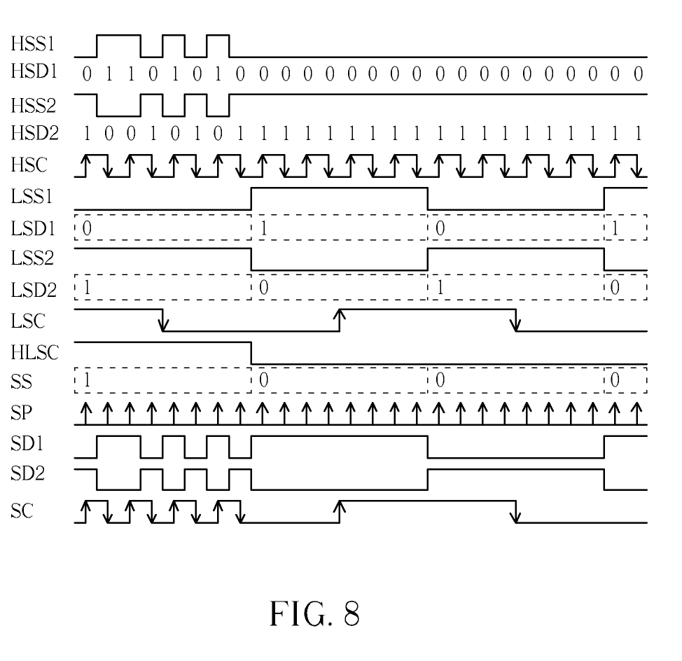

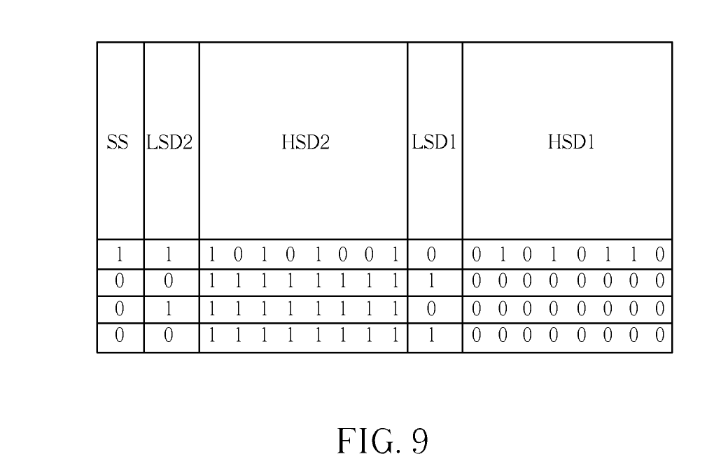

Through the flowchart 50, when the data processing unit 408 describes the high/low speed serial signals, the present invention uses different sampling rates to describe the high/low speed signals, and furthermore, the sampling result of the low-speed data is expressed in the serial format, and the high-speed data is expressed in the parallel format. By this way, the number of bits used for describing the low-speed data within a specified duration can be decreased significantly. Please notice that FIG. 6 and FIG. 7 are the situations that both the high-speed and the low-speed data are expressed in the serial format. Those skilled in the art can apply the present invention to different applications according to their needs. For example, please refer to FIG. 8 and FIG. 9. FIG. 8 shows a schematic diagram of two sets of the high-speed and the low-speed serial transmission signals generated by the data processing unit 408. FIG. 9 is a schematic diagram of the sampling result corresponding to FIG. 8. Symbols used in FIG. 8 and FIG. 9 have similar definitions used in the figures aforementioned. The difference is that the numbers “1” and “2” appended in the symbols in FIG. 8 and FIG. 9 corresponds to the first set and the second set of the high/low speed serial transmission signal. For example, HSS1 denotes high speed signal of the first set, and HSS2 denotes high speed signal of the second set, and so forth.

As known in FIG. 8 and FIG. 9, the high-speed data is expressed in a sampling rate of higher speed, and the low-speed data is expressed in a sampling rate of lower speed. Therefore, the number of bits included in the field corresponding to the sampling result of the low-speed data is obviously less than the number of bits corresponding to the sampling result of the high-speed data. Again, the sampling result of the low-speed data is expressed in the serial format, and the sampling result of the high-speed data is expressed in the parallel format.

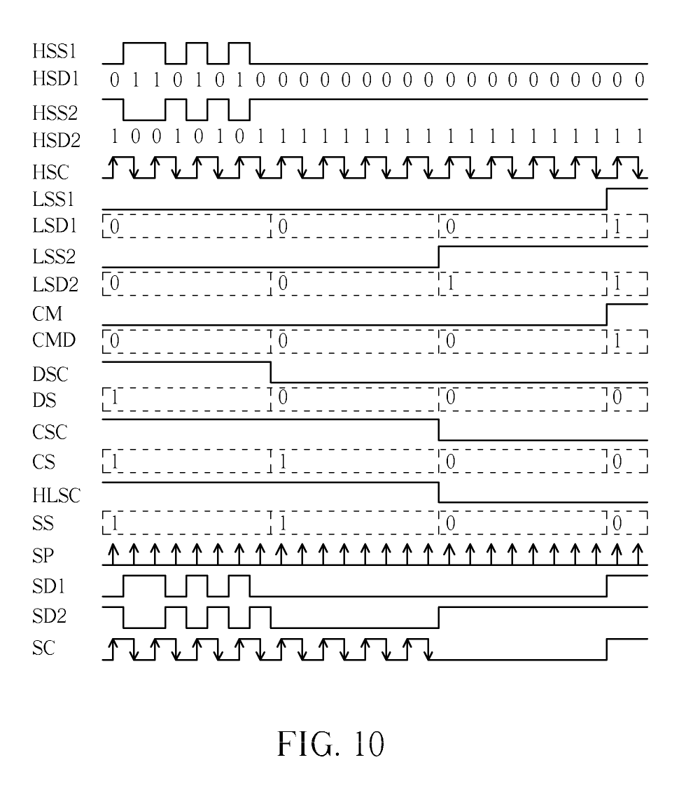

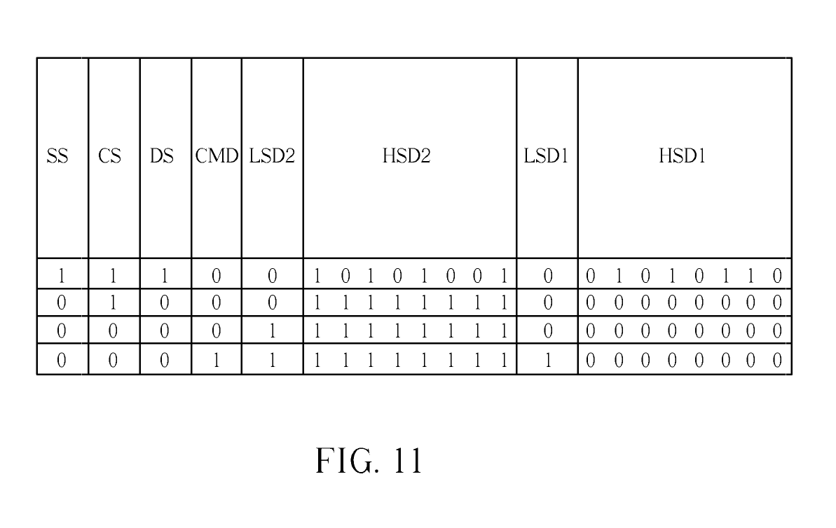

Moreover, please refer to FIG. 10 and FIG. 11. FIG. 10 shows a schematic diagram of two sets of the high and low speed serial transmission signals generated by the data processing unit 408. FIG. 11 is a schematic diagram of the sampling result corresponding to FIG. 10. Symbols used in FIG. 10 and FIG. 11 have similar definitions used in FIG. 6 and FIG. 7. The differences are those, in FIG. 10 and FIG. 11, more signals are included: CM denotes clock mode signal, CMD denotes clock mode data, DSC denotes data control switch signal, DS denotes data switch control data, CSC denotes clock switch control signal, and CS denotes clock switch data. HSD1, LSD1, HSD2, LSD2, CMD, CS and SS are the format signals generated by the data transformation unit 406. SD1, SD2 and SC are the format signals generated by the serial transmission interface 404. DS is used for switching of SD1 data between HSD1 and LSD1. DS is also used for switching of SD2 data between HSD2 and LSD2. DS is used for switching of SD2 data between HSD2 and LSD2. CS is used for switching of SC data between HSC and CMD. As was known in FIG. 10 and FIG. 11, the high-speed data is expressed in a sampling rate of higher speed, and the low-speed data is expressed in a sampling rate of lower speed. Therefore, the number of bits included in the field corresponding to the sampling result of the low-speed data is obviously less than the number of bits corresponding to the sampling result of the high-speed data. Moreover, the sampling result of the low-speed data is expressed in the serial format, and the sampling result of the high-speed data is expressed in the parallel format.

To summarize, the present invention uses the sampling rate of a higher speed to describe the high-speed data, and the sampling rate of a lower speed to describe the low-speed data. As a result, the number of bits included in the field corresponding to the sampling result of the low-speed data is clearly less than the number of bits corresponding to the sampling result of the high-speed data. The sampling result of the low-speed data is expressed in the serial format, and the sampling result of the high-speed data is expressed in the parallel format. Under these conditions, not only the number of bits used for describing the low-speed data is decreased, but also the sampling result of the high-speed data can be expressed in the parallel format such that the data transformation unit 406 can be allowed to have more time to process the sampling result and increase the total performance.

Those skilled in the art will readily observe that numerous modifications and alterations of the device and method may be made while retaining the teachings of the invention.

What is claimed is:

1. A data description method for a serial transmission interface comprising:
generating a low-speed data and a high-speed data simultaneously;
sampling the low-speed data to generate a first sampling result according to a first sampling rate within a specified duration;
sampling the high-speed data to generate a second sampling result according to a second sampling rate within the specified duration; and
combining the first sampling result and the second sampling result to describe contents of the low-speed data and the high-speed data within the specified
duration.

2. The method of claim 1, wherein the first sampling rate is corresponding to a transmission rate of the low-speed data, and the second sampling rate is corresponding to a transmission rate of the high-speed data.

3. The method of claim 1, wherein the first sampling result comprises a first number of binary data, the second sampling result comprises a second number of binary data, and the second number is greater than the first number.

4. The method of claim 3, wherein the first number is 1.

5. The method of claim 3, wherein the first sampling result is expressed as the first number of binary data in a serial format.

6. The method of claim 3, wherein the second sampling result is expressed as the second number of binary data in a parallel format.

7. A packet for describing a high-speed data and a low-speed data in a serial transmission interface comprising:
a first field comprising a first number of binary data for describing a first sampling result generated by sampling the low-speed data at a first sampling rate within a specified duration; and
a second field comprising a second number of binary data for describing a second sampling result generated by sampling the high-speed data at a second sampling rate within a specified duration.

8. The packet of claim 7, wherein the first sampling rate is corresponding to a transmission rate of the low-speed data, and the second sampling rate is corresponding to a transmission rate of the high-speed data.

9. The packet of claim 7, wherein the first number is 1.

10. The packet of claim 7, wherein the first number of binary data is expressed in a serial format.

11. The packet of claim 7, wherein the second number of binary data is expressed in a parallel format.

12. A testing system for testing a communication device comprising:
a reception unit built inside the communication device for receiving a test pattern;
a transmission unit for outputting the test pattern;
a serial transmission interface coupled between the reception unit and the transmission unit for transmitting the test pattern;
a data transformation unit coupled to the serial transmission interface for transforming a description content to generate the test pattern; and
a data processing unit coupled to the data transfer unit for generating a low-speed data and a high-speed data simultaneously, sampling the low-speed data to generate a first sampling result according to a first sampling rate within a specified duration, sampling the high-speed data to generate a second sampling result according to a second sampling rate within the specified duration, and combining the first sampling result and the second sampling result to describe contents of the low-speed data and the high-speed data within the specified duration.

13. The testing system of claim 12, wherein the first sampling rate is corresponding to a transmission rate of the low-speed data, and the second sampling rate is corresponding to a transmission rate of the high-speed data.

14. The testing system of claim 12, wherein the first sampling result contains a first number of binary data, the second sampling result contains a second number of binary data, and the second number is greater than the first number.

15. The testing system of claim 14, wherein the first number is 1.

16. The testing system of claim 14, wherein the first sampling result is expressed as the first number of binary data in a serial format.

17. The testing system of claim 14, wherein the second sampling result is expressed as the second number of binary data in a parallel format.
